(19) United States
(12) Patent Application Publication
(10) Pub. No.: US 2013/0173923 A1
(43) Pub. Date: Jul. 4, 2013

(54) METHOD AND SYSTEM FOR DIGITAL CONTENT SECURITY COOPERATION

(71) Applicants: PEKING UNIVERSITY, Beijing (CN); PEKING UNIVERSITY FOUNDER GROUP CO., LTD., Beijing (CN); BEIJING FOUNDER APABI TECHNOLOGY LTD., Beijing (CN)

(72) Inventors: Qin QIU, Beijing (CN); Zhi Tang, Beijing (CN); Yinyan Yu, Beijing (CN)

(73) Assignees: PEKING UNIVERSITY, Beijing (CN); BEIJING FOUNDER APABI TECHNOLOGY LTD., Beijing (CN); PEKING UNIVERSITY FOUNDER GROUP CO., LTD., Beijing (CN)

(21) Appl. No.: 13/731,562

(22) Filed: Dec. 31, 2012

(30) Foreign Application Priority Data
Dec. 30, 2011 (CN) 201110457870.8

(51) Int. Cl. H04L 9/32

(52) U.S. Cl. CPC H04L 9/3281; H04L 63/0407
USPC 713/176; 726/4

(57) ABSTRACT

A method for digital content security cooperation, including: creating, by a first content possessing device, a cooperation content packet of digital contents and transmitting the created cooperation content packet to at least one of a second content possessing device or a first content cooperating device, wherein the cooperation content packet includes an attribute data block and a content data block; and performing, by the first content cooperating device receiving the cooperation content packet, privilege verification according to the cooperation content packet, and after the privilege verification is passed, updating the information in the content data block in the cooperation content packet, and transmitting the cooperation content packet including the updated information to at least one of a second content cooperating device or the first content possessing device.

### RELATED APPLICATIONS

This application is based upon and claims the benefit of priority from Chinese Patent Application No. 201110457870.8, filed Dec. 30, 2011, the entire contents of which are incorporated herein by reference.

### FIELD

The present invention relates to the field of digital content security technologies and, particularly, to a method and system for digital content security cooperation.

### BACKGROUND

As electronic devices and Internet applications become more popular and well developed, more and more users have become active producers of digital contents, and there is more network-based interpersonal cooperation. Content cooperation has become a common behavior in daily life of people. Very often, a plurality of authors create digital works collectively, or an expert helps an author to revise and refine digital works.

A digital rights management technology enables a content possessing device to define who can use digital contents and how to use them as an important content protection pattern. An existing Digital Rights Management (DRM) mechanism is often intended to protect formally published digital contents to ensure that only a legally authorized user can use the digital contents in accordance with his or her granted privilege. Generally the content possessing device encapsulates a digital content ciphertext and integrity verification information into a digital content packet to prevent the contents from being illegally accessed and falsified. Only an authorized content using device can decrypt and use the digital contents in the digital content packet in accordance with a license after successfully verifying the integrity of the content packet.

The existing DRM mechanism usually assumes that digital contents reside in a security controllable environment before being formally published almost without taking into account the provision of protection for the digital contents in a creation process prior to formal publication. However, in a content cooperation scenario, the creation process involves a plurality of participants, the security of the digital contents may be nondeterministic and uncontrollable in an interaction process of the respective participants. If the digital contents are not protected in a content cooperation process, the digital contents may be susceptible to illegal use and spreading by an eavesdropper or a malicious content cooperating device.

### SUMMARY

According to a first aspect of the present disclosure, there is provided a method for digital content security cooperation, comprising: creating, by a first content possessing device, a cooperation content packet of digital contents and transmitting the created cooperation content packet to at least one of a second content possessing device or a first content cooperating device, wherein the cooperation content packet includes an attribute data block and a content data block, the attribute data block includes information that may be updated only by a content possessing device, and the content data block includes information that may be updated by a content possessing device or by a content cooperating device; performing, by the first content cooperating device receiving the cooperation content packet, privilege verification according to the cooperation content packet, and after the privilege verification is passed, updating the information in the content data block in the cooperation content packet, and transmitting the cooperation content packet including the updated information to at least one of a second content cooperating device or the first content possessing device; and performing, by the first content possessing device, privilege verification according to the cooperation content packet after receiving the cooperation content packet, and after the privilege verification is passed, updating at least one of the information in the attribute data block or the content data block in the cooperation content packet and transmitting the cooperation content packet including the updated information.

According to a second aspect of the present disclosure, there is provided a system for digital content security cooperation, comprising a first content possessing device and a first content cooperating device, wherein: the first content possessing device may be configured to create a cooperation content packet of digital contents and to transmit the created cooperation content packet to at least one of a second content possessing device or the first content cooperating device, wherein the cooperation content packet includes an attribute data block and a content data block, the attribute data block includes information that may be updated only by a content possessing device, and the content data block includes information that may be updated by a content possessing device or by a content cooperating device; the first content cooperating device may be configured to perform privilege verification according to the cooperation content packet after receiving the cooperation content packet, and after the privilege verification is passed, to update the information in the content data block in the cooperation content packet, and to transmit the cooperation content packet including the updated information to at least one of a second content cooperating device or the first content possessing device; and the first content possessing device is further configured to perform privilege verification according to the cooperation content packet after receiving the cooperation content packet, and after the privilege verification is passed, to update the information in at least one of the attribute data block or the content data block in the cooperation content packet, and to transmit the cooperation content packet including the updated information.

It is to be understood that both the foregoing general description and the following detailed description are exemplary and explanatory only and are not restrictive of the invention, as claimed.

### BRIEF DESCRIPTION OF THE DRAWINGS

FIG. 1A illustrates a block diagram of a system for digital content security cooperation, according to an exemplary embodiment.

FIG. 1B illustrates a flowchart of a method for digital content security cooperation, according to an exemplary embodiment.

FIG. 1C illustrates a block diagram of an attribute data block and a content data block in a cooperation content packet, according to an exemplary embodiment.

FIG. 2A illustrates a flowchart of a method for digital content security cooperation, according to an exemplary embodiment.

FIG. 2B illustrates a flowchart of a method for digital content security cooperation, according to an exemplary embodiment.

FIG. 3 illustrates a block diagram of a content possessing device, according to an exemplary embodiment.

FIG. 4 illustrates a block diagram of a content coordinating device, according to an exemplary embodiment.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

In exemplary embodiments, one or more units disclosed in this disclosure may be implemented via one or more processors executing software programs for performing functionalities. In some embodiments, one or more of the disclosed units are implemented via one or more hardware modules executing firmware for performing functionalities. In some embodiments, one or more of the disclosed units include storage media for storing data, or software or firmware programs executed by the units.

In exemplary embodiments, there is provided a method for digital content security cooperation in which a cooperation content packet created by a content possessing device includes, e.g., an attribute data block that can be updated only by a content possessing device and a content data block that can be updated by a content possessing device and/or a content cooperating device. The content possessing device may update information in the attribute data block and the content data block after performing privilege verification, and the content cooperating device may update only the information in the content data block after performing privilege verification.

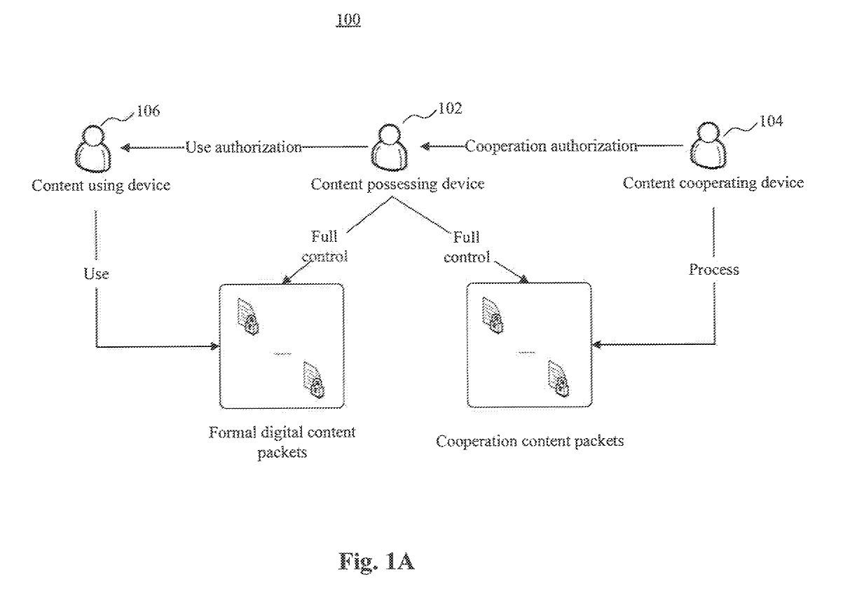

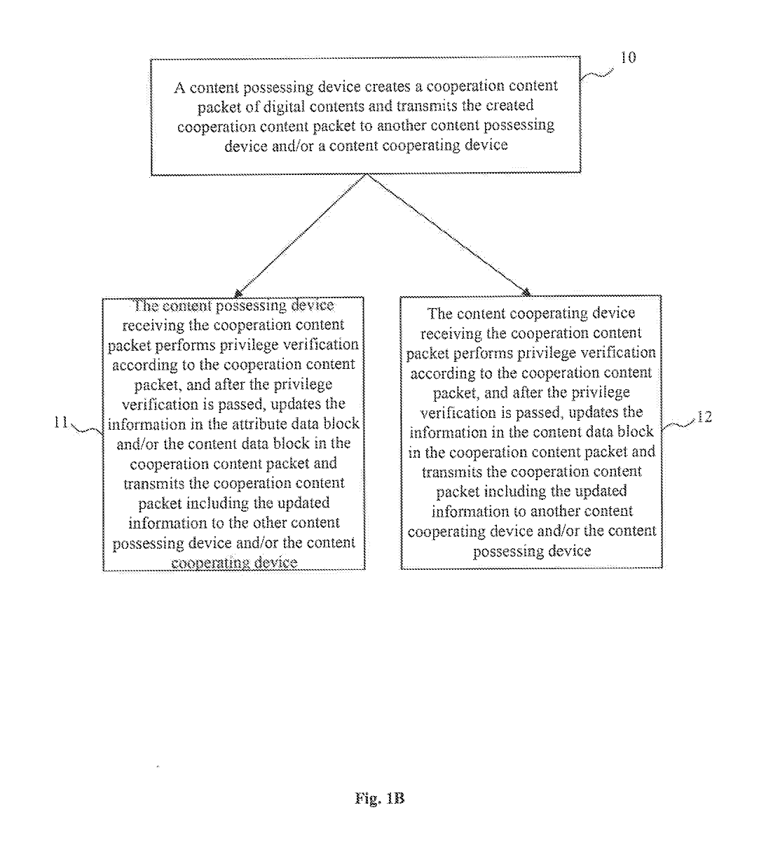

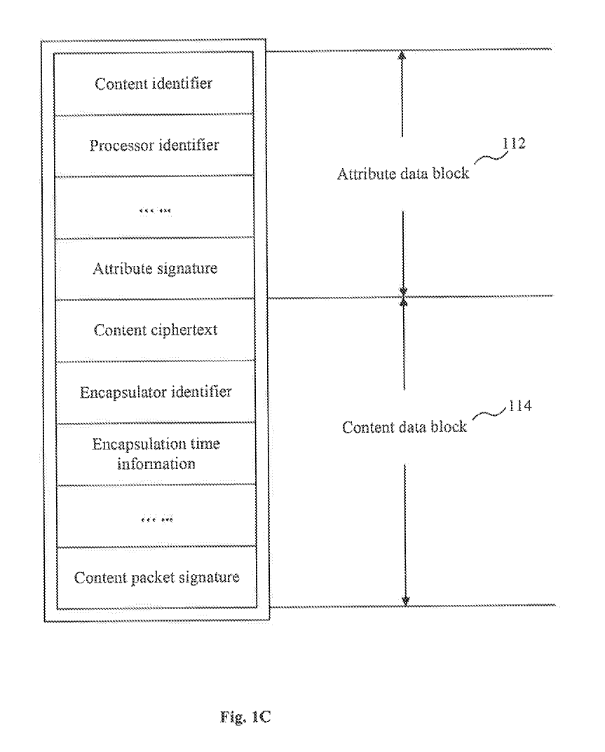

FIG. 1A illustrates a block diagram of a system 100 for digital content security cooperation, according to an exemplary embodiment. Referring to FIG. 1A, the system 100 includes a content possessing device 102 and a content cooperating device 104. The system 100 may also include a content using device 106. In the illustrated embodiment, devices that can participate in content cooperation may include at least one content possessing device, and one or more content cooperating devices, and may perform multi-party and repeated processing of contents including, e.g., editing the contents, adding an annotation, etc. The processed contents of respective versions typically have the same general attribute and privilege setting as the original contents.

In exemplary embodiments, the content possessing device 102 may be a copyright owner of the digital contents, have manipulation rights to the digital contents, and may perform operations of creation, setting attribute information, processing, authorization, etc., on the digital contents. In cooperation, there may be a plurality of content possessing devices at a same top level which may negotiate about the security of crucial information, including a content key and a signature private key.

In exemplary embodiments, the content cooperating device 104 may process the protected digital contents (of respective versions), in the state of using bound hardware, after obtaining a cooperative license bound with the hardware. The bound hardware may be an electronic device with a calculation or secured storage function, e.g., a computer equipped at the office, a certified USB key, or a smart key device.

In exemplary embodiments, the content using device 106 may use cooperatively created and formally published digital contents after obtaining use authorization.

Digital contents may include formal digital content packets and cooperation content packets. For example, formal digital content packets may be data packets including formally published digital contents, and cooperation content packets may be data packets including digital contents being cooperatively created. The content possessing device 102 may have full control of both the formal digital content packets and the cooperation content packets. The content cooperating device 104 may process the cooperation content packets. The content using device 106 may use the formal digital content packets after authorization.

FIG. 1B illustrates a flowchart of a method for digital content security cooperation, according to an exemplary embodiment. Referring to FIG. 1B, the method may include the following steps.

Step 10: A content possessing device, such as the content possessing device 102 (FIG. 1A), may create a cooperation content packet of digital contents and transmit the created cooperation content packet to another content possessing device and/or a content cooperating device. The created cooperation content packet may include an attribute data block and a content data block, the attribute data block including information that may be updated only by a content possessing device, and the content data block including information that may be updated by a content possessing device and/or a content cooperating device;

Step 11: A content possessing device receiving the cooperation content packet may perform privilege verification according to the cooperation content packet, and after the privilege verification is passed, update the information in the attribute data block and/or the content data block in the cooperation content packet, and transmit the cooperation content packet including the updated information to the other content possessing device and/or the content cooperating device; and

Step 12: The content cooperating device receiving the cooperation content packet may perform privilege verification according to the cooperation content packet, and after the privilege verification is passed, update the information in the content data block in the cooperation content packet, and transmit the cooperation content packet including the updated information to another content cooperating device and/or the content possessing device.

FIG. 1C shows a block diagram of an attribute data block 112 and a content data block 114 in a cooperation content packet, according to an exemplary embodiment. Referring to FIG. 1C, the attribute data block 112 may include attribute information and an attribute signature of the digital contents, and the content data block 114 may include a content ciphertext, and encapsulation information and a content packet signature of the cooperation content packet.

In exemplary embodiments, the attribute signature may be a digital signature of the content possessing device on the attribute information, the content ciphertext may be a ciphertext into which the content possessing device encrypts the digital contents by a content key, and the content packet signature is a digital signature of the content possessing device on the content ciphertext, the encapsulation information and the attribute information, or a digital signature of the content possessing device on the content ciphertext, the encapsulation information and the attribute signature.

The attribute signature may be generated in the following process: the content possessing device may obtain a digest of the attribute information using a message digest function and then obtain a digital signature of the digest by its own private key and a digital signature algorithm. Similarly, the content packet signature may be generated in the following process: the content possessing device may obtains a digest of the content ciphertext, the encapsulation information and the attribute information (or the content ciphertext, the encapsulation information and the attribute signature) using the message digest function and then obtain a digital signature of the digest by its own private key and the digital signature algorithm.

In exemplary embodiments, the attribute information may include a content identifier of the digital contents and an identifier of the content possessing device, and the encapsulation information in the cooperation content packet may include an encapsulator identifier and encapsulation time information. The encapsulator identifier may be an identifier of the device encapsulating the current cooperation content packet. The encapsulation time information may be used to distinguish between different versions of the cooperation content packet, and may be an encapsulation time or a version sequence number of the cooperation content packet.

Referring back to FIG. 1B, step 11 may be performed in the following three exemplary approaches.

In the first exemplary approach, the content possessing device receiving the cooperation content packet may verify the attribute signature and the content packet signature in the cooperation content packet, and after the verification is passed, may update the attribute information, the encapsulation information, the attribute signature, and the content packet signature in the cooperation content packet, and may transmit the cooperation content packet, including the updated attribute information, encapsulation information, attribute signature and content packet signature, and the content ciphertext prior to updating, to another content possessing device and/or content cooperating device.

In one exemplary embodiment, the updated encapsulation information may include a current encapsulator identifier and encapsulation time information, the updated attribute signature is a digital signature of the content possessing device on the updated attribute information and generated in a similar method to the foregoing method of generating the attribute signature, and the updated content packet signature is a digital signature of the content possessing device on the updated attribute information (or attribute signature), the updated encapsulation information, and the content ciphertext prior to updating and generated in a similar method to the foregoing method of generating the content packet signature.

In the second exemplary approach, the content possessing device receiving the cooperation content packet may verify the attribute signature and the content packet signature in the cooperation content packet, and after the verification is passed, may decrypt the content ciphertext in the cooperation content packet by the content key, update a content plaintext obtained by the decryption and encrypts the updated content plaintext by the content key into an updated content ciphertext; and update the encapsulation information and the content packet signature in the cooperation content packet and may transmit the cooperation content packet including the updated content ciphertext, content packet signature and encapsulation information, and the attribute information and the attribute signature prior to updating, to another content possessing device and/or the content cooperating device.

In one exemplary embodiment, the respective content possessing devices may pre-share the content key used to encrypt the digital contents. The updated encapsulation information may include a current encapsulator identifier and encapsulation time information. The updated content packet signature may be a digital signature of the content possessing device on the updated attribute information (or attribute signature), the updated encapsulation information, and the updated content ciphertext, and may be generated in a similar method to the foregoing method of generating the content packet signature.

In the third exemplary approach, the content possessing device receiving the cooperation content packet may verify the attribute signature and the content packet signature in the cooperation content packet, and after the verification is passed, may update the attribute information in the cooperation content packet, decrypt the content ciphertext in the cooperation content packet by the content key, update a content plaintext obtained by the decryption and encrypt the updated content plaintext by the content key into an updated content ciphertext; and update the encapsulation information, the attribute signature and the content packet signature in the cooperation content packet and may transmit the cooperation content packet including the updated attribute information, attribute signature, content ciphertext, encapsulation information and content packet signature to another content possessing device and/or content cooperating device.

In one exemplary embodiment, the respective content possessing devices may pre-share the content key used to encrypt the digital contents. The updated attribute signature may be a digital signature of the content possessing device on the updated attribute information and generated in a similar method to the foregoing method of generating the attribute signature. The updated encapsulation information may include a current encapsulator identifier and encapsulation time information. The updated content packet signature is a digital signature of the content possessing device on the updated attribute information (or attribute signature), the updated encapsulation information, and the updated content ciphertext, and is generated in a similar method to the foregoing method of generating the content packet signature.

The content possessing device receiving the cooperation content packet may verify the attribute signature and the content packet signature in the cooperation content packet as follows.

In one exemplary embodiment, the content possessing device receiving the cooperation content packet may verify the attribute signature by the private key used by the content possessing device creating the cooperation content packet to generate the attribute signature in the cooperation content packet. For example, the attribute information in the cooperation content packet is re-signed by the private key, and if a newly obtained attribute signature is consistent with the attribute signature in the cooperation content packet, the verification may be passed; otherwise, the verification may fail. The respective content possessing devices may pre-share the private key used to generate the attribute signature in the cooperation content packet.

In one exemplary embodiment, the content possessing device receiving the cooperation content packet may determine the device encapsulating the cooperation content packet according to the encapsulation information in the cooperation content packet, and may verify the content packet signature in the cooperation content packet by a public key corresponding to that device. For example, the content packet signature in the cooperation content packet may be decrypted by the public key to obtain a first digest, and a second digest of the attribute information (or the attribute signature) with the content ciphertext and the encapsulation information in the cooperation content packet may be obtained by using a message digest function. If the second digest is consistent with the first digest obtained by the decryption, the verification may be passed; otherwise, the verification may fail.

In exemplary embodiments, after the content possessing device creates the cooperation content packet of the digital contents, the content possessing device creating the cooperation content packet may issue a cooperation license of the created cooperation content packet to the content cooperating device by itself or through a trusted third party. The cooperation license may include authorization information and an authorization signature. The authorization information may include the attribute information and a content key ciphertext in the cooperation content packet, the content key ciphertext being a ciphertext into which the content key is encrypted by a key stored or generated by bound hardware. The authorization signature may be a digital signature of an authorizer on the authorization information, and may be generated in the following process: the authorizer may obtain a digest of the authorization information using a message digest function and then obtain a digital signature of the digest by its own private key and a digital signature algorithm.

In exemplary embodiments, the authorization information may further include rights information used to declare a processing operation that can be performed by the content cooperating device on the cooperation content packet. The bound hardware may be hardware residing in a specified area or hardware belonging to an authorized content cooperating device.

Referring back to FIG. 1B, step 12 may be implemented as follows.

The content cooperating device receiving the cooperation content packet may verify the authorization signature in the cooperation license, and the attribute signature and the content packet signature in the cooperation content packet. After the verification is passed, the content cooperating device may determine whether the attribute information in the cooperation license is consistent with the attribute information in the cooperation content packet. Upon positive determination: the content cooperating device, in the state of using bound hardware, may obtain the key stored or generated by the bound hardware, and decrypt the content key ciphertext in the cooperation license by the obtained key. The content cooperating device may also decrypt the content ciphertext in the cooperation content packet by the content key obtained by the decryption, update the content plaintext obtained by the decryption, and encrypt the updated content plaintext by the content key into an updated content ciphertext. As a result, the encapsulation information and the content packet signature in the cooperation content packet may be updated. The cooperation content packet, including the updated content ciphertext, content packet signature and encapsulation information, and the attribute information and the attribute signature prior to updating, may be transmitted to another content cooperating device and/or content possessing device.

In one exemplary embodiment, the updated encapsulation information may include a current encapsulator identifier and encapsulation time information. The updated content packet signature may be a digital signature of the attribute information (or attribute signature) prior to updating, the updated encapsulation information and the updated content ciphertext, and may be generated in a similar method to the foregoing method of generating the content packet signature.

The content cooperating device receiving the cooperation content packet may verify the authorization signature in the cooperation license, and the attribute signature and the content packet signature in the cooperation content packet particularly as follows.

In one exemplary embodiment, the content cooperating device receiving the cooperation content packet may verify the authorization signature in the cooperation license according to a public key of the device issuing the cooperation license. For example, the authorization signature in the cooperation license may be decrypted by the public key to obtain a digest, a digest of the authorization information in the cooperation license may be obtained using a message digest function, and if the digest is consistent with the digest obtained by the decryption, the verification may be passed; otherwise, the verification may fail.

In one exemplary embodiment, the content cooperating device receiving the cooperation content packet may determine the device encapsulating the cooperation content packet according to the encapsulation information in the cooperation content packet, and may verify the attribute signature and the content packet signature in the cooperation content packet by a public key corresponding to the device. For example, the attribute signature in the cooperation content packet may be decrypted by the public key to obtain a digest, a digest of the attribute information in the cooperation content packet may be obtained using a message digest function, and if the digest is consistent with the digest obtained by the decryption, the verification may be passed; otherwise, the verification may fail. Also for example, the content packet signature in the cooperation content packet may be decrypted by the public key to obtain a digest, a digest of the attribute information (or the attribute signature), the content ciphertext and the encapsulation information in the cooperation content packet may be obtained using a message digest function, and if the digest is consistent with the digest obtained by the decryption, the verification may be passed; otherwise, the verification may fail.

In addition, when the key used to generate the content key ciphertext is a public key stored or generated by the bound hardware, the key used by the content cooperating device to decrypt the content key ciphertext in the cooperation license may be a private key stored or generated by the bound hardware. When the key used to generate the content key ciphertext is a symmetric key stored or generated by the bound hardware, the key used by the content cooperating device to decrypt the content key ciphertext in the cooperation license may be the symmetric key.

In exemplary embodiments, after the cooperation content packet is updated at least once by the content possessing device and/or the content cooperating device, the content possessing device creating the cooperation content packet may verify the attribute signature and the content packet signature in the cooperation content packet after receiving the updated cooperation content packet transmitted from the content cooperating device or another content possessing device, decrypt the content ciphertext in the cooperation content packet by the content key after the verification is passed, and create a digital content packet for formal publication according to the reviewed and confirmed content plaintext, after a user reviews and confirms the content plaintext obtained by the decryption, which may be implemented in the following two exemplary approaches.

In the first exemplary approach, the created and published digital content packet may be in the same format as the cooperation content packet and may include attribute information of the digital contents, a digital signature of the attribute information, i.e., an attribute signature, a digital content ciphertext into which the reviewed and confirmed content plaintext may be encrypted by the content key, encapsulation information of the digital content packet, and a digital content packet signature which is a digital signature of the content possessing device on the digital content ciphertext, the encapsulation information and the attribute information (or the attribute signature).

After the digital content packet for formal publication is created and published, the content possessing device creating the cooperation content packet may issue a use license of the digital content packet to a content using device by itself or through a trusted third party. The use license may include license information and a license signature. For example, the license information may include the attribute information and a digital content key ciphertext in the digital content packet, and the digital content key ciphertext is a ciphertext into which the content key is encrypted by a public key of the content using device. Also for example, the license signature is a digital signature of an authorizer (the content possessing device creating the cooperation content packet itself or the trusted third party) on the license information.

The content using device may verify the license signature in the use license, and the content packet signature and the attribute signature in the content digital packet, and after the verification is passed, may decrypt the digital content key ciphertext in the use license by its own private key, decrypt the digital content ciphertext in the content digital packet by the content key obtained by the decryption and uses the contents obtained by the decryption.

In the second exemplary approach, the created and published digital content packet may include attribute information of the digital contents, a digital content ciphertext into which the reviewed and confirmed content plaintext is encrypted by the content key, and a digital content packet signature which is a digital signature of the content possessing device on the digital content ciphertext and the attribute information.

After the digital content packet for formal publication is created and published, the content possessing device creating the cooperation content packet may issue a use license of the digital content packet to a content using device by itself or through a trusted third party. The use license may include license information and a license signature. For example, the license information may include the attribute information and a digital content key ciphertext in the digital content packet, and the digital content key ciphertext may be a ciphertext into which the content key is encrypted by a public key of the content using device. Also for example, the license signature may be a digital signature of an authorizer (the content possessing device creating the cooperation content packet itself or the trusted third party) on the license information.

The content using device may verify the license signature in the use license, and the content packet signature and the attribute signature in the content digital packet, and after the verification is passed, may decrypt the digital content key ciphertext in the use license by its own private key, decrypt the digital content ciphertext in the content digital packet by the content key obtained by the decryption and uses the contents obtained by the decryption.

The invention is now described below in combination with first and second exemplary embodiments.

### First Exemplary Embodiment

The first exemplary embodiment provides a method for digital content security cooperation for a scenario where a project manager and an assistant of a company cooperate in writing a project report, where a content cooperating device is a computer device assigned in the company, and a formally published digital content packet is in the same structure as that of a cooperation content packet. In the illustrated embodiment, a content possessing device may be a device A used by the manager, and is referred to hereafter as “A.” A content cooperating device may be a device B used by the assistant, and is referred to hereafter as “B.” A content using device may be a device C used by a general manager of the company, and is referred to hereafter as “C.” The respective devices perform relevant security operations through reliable DRM software, including generating and storing a key, creating, updating or parsing a content packet, creating or parsing a license, processing or using contents as per a privilege, etc. For a symmetric encryption mechanism, particularly an Advanced Encryption Standard (AES), an International Data Encryption Algorithm (IDEA), etc., may be adopted; for a message digest function, MD5, SHA-1, etc., may be adopted; and for a digital signature, RSA, DSS and other algorithms may be adopted.

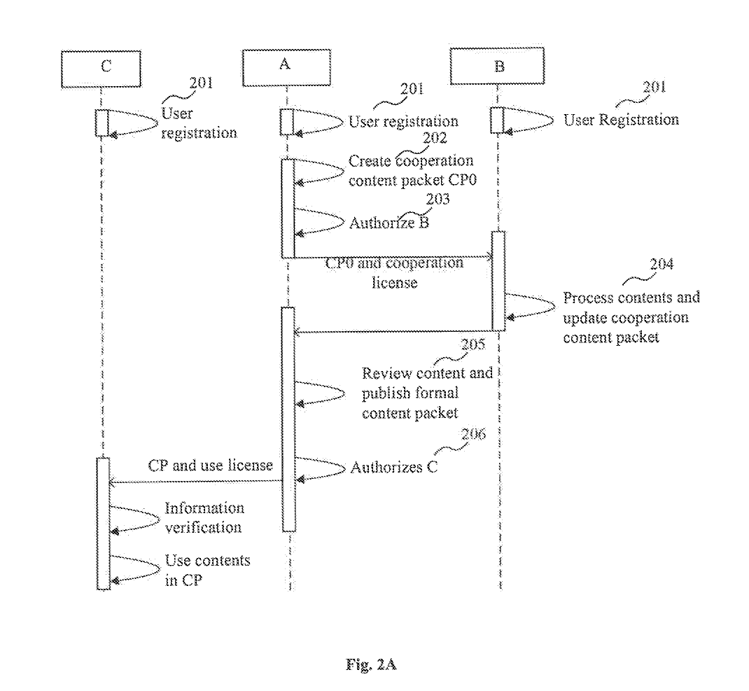

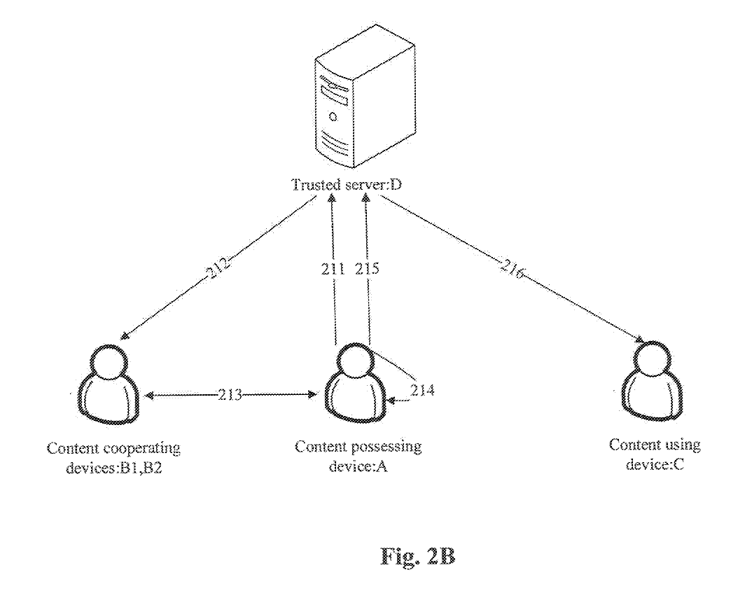

FIG. 2A illustrates a flowchart of the method for digital content security cooperation, according to the first exemplary embodiment.

Step 201: Users Register.

In order to ensure the security of important data in a company, DRM software may be installed on a computer of each employee to ensure that only an authorized employee can create, process or read data on a specified computer. In a user registration phase, each employee may open a registration interface of the DRM software on his or her own computer and enter his or her own employee number as a user identifier, and the DRM software may extract device parameter information of the computer of the employee and generate a pair of public and private keys of the device, and then upload the employee number of the user and the generated public key of the device to a server of the company. The server may publish the employee numbers of all the employees and the corresponding public keys of the devices after checking and confirmation.

Step 202: A Creates an Original Cooperation Content Packet.

The user using A may draft a project report and then select a function of “Create a cooperation content packet” on the DRM software and set a content status flag to “Being created”, and A may create an initialized cooperation content packet CP0 for the report. DRM client software may extract the employee number of A, ID(A), from system setting and generate a unique content identifier i and a random content key CEK for the report, thus resulting in CP0. In CP0, attribute information may include the content identifier i, a content possessing device identifier ID(A) and the content status flag of “Being created”, an attribute signature may be generated by signing a digest of the attribute information by a device private key of A, a content ciphertext may be generated by encrypting a plaintext of the report symmetrically by the CEK, an encapsulator identifier is ID(A), encapsulation time information may be a current system time, and a content packet signature is generated by signing a digest of the attribute signature, the content ciphertext and the encapsulation time information by the device private key of A.

Step 203: A Authorizes B.

A may create a cooperation license for B via the DRM software, which may include the content identifier i, a possessor identifier ID(A), a content key ciphertext, rights information authorized to B, and a signature made on a digest of the above information by the device private key of A. The content key ciphertext may be generated by encrypting the CEK by the device public key of B.

Step 204: B Processes the Contents and Updates the Cooperation Content Packet.

A may transmit the cooperation content packet CP0 and the cooperation license to B in an e-mail to instruct B to supplement and refine the contents of the report.

After B obtains the cooperation license and CP0, the DRM software of B may first verify the signature of A in the cooperation license and the content packet signature and the attribute signature in CP0, and may then confirm that the content identifier i in CP0 is consistent with the content identifier i in the cooperation license and that the content status flag in CP0 is “Being created”. Upon successful verification, the DRM software of B may generate a device private key according to device information, decrypt the content key ciphertext in the cooperation license by the device private key, and further decrypt the content ciphertext in CP0 by the obtained content key CEK into the content plaintext. The user using B may then supplement and refine the content plaintext in accordance with an obtained privilege.

After the user using B finishes the processing operations, the DRM software of B may encrypt the updated plaintext of the report by the content key CEK extracted from the cooperation license into an updated content ciphertext, and may then create an updated cooperation content packet CP1, wherein attribute information of CP1 may be the same as the attribute information in CP0, an attribute signature of CP1 may be the same as the attribute signature in CP0, a content ciphertext of CP1 may be the updated content ciphertext, an encapsulator identifier of CP1 is the user identifier of B, ID(B), an encapsulation time of CP1 may be a current system time, and a content packet signature of CP1 may be a signature made on a digest of the attribute signature of CP1, the content ciphertext of CP1 and the encapsulation time information of CP1 by the device private key of B.

Step 205: A Reviews the Contents and Publishes a Formal Content Packet.

B may transmit CP1 to A in an e-mail. A may verify the content packet signature and the attribute signature in CP1 via the DRAM software. Next, A may decrypt the content ciphertext in CP1 by the CEK, and A may be used to review and confirm the content plain-text and adjust the content plain-text dependent upon a practical condition, thus resulting in a final content plain-text M. Upon confirmed completion, A may create a formal content packet CP. For example, A may first store the content identifier i in CP1, the possessor identifier ID(A), and the content ciphertext into which M may be encrypted by the CEK into corresponding items of CP, and then set the content status flag in the attribute information of CP to “Formally published” and sign a digest of the attribute information of CP by its own device private key to generate an attribute signature of CP. Further, A may set an encapsulator identifier to its own user identifier ID(A), set encapsulation time information to a current system time, and sign a digest of the attribute signature, the content ciphertext and the encapsulation time information of CP by its own device private key to generate a content packet signature.

Step 206: A Authorizes C to Use the Formally Published Contents.

A may create a use license for C, which may include the content identifier i, a content key ciphertext, use rights information of C, and a signature of A on a digest of the above information by the device private key. The content key ciphertext may be generated by A encrypting the content key CEK by the device public key of C. After the license is created, A may transmit the formally published digital content packet CP and the use license to C in an c-mail.

Before using the protected project report, C firstly may verify the content packet signature and the attribute signature in CP and confirm that the content possessing device identifier and the encapsulator identifier in CP are consistent and that the content status flag is “Formally published”. If the verification fails, C may abort the use of the contents in CP. If the verification is successful, C may continue to verify the use license for integrity and then decrypt the content key ciphertext in the use license by its own device private key, decrypt the content ciphertext in CP by the obtained content key CEK, and finally the user using C may use the project report in CP as per a granted privilege.

### Second Exemplary Embodiment

The second exemplary embodiment provides a method for digital content security cooperation for a scenario where a writer creates digital works under the cooperation of an assistant and sells the digital works through a digital content dealer. In this embodiment, a content possessing device may only cooperate in the status of using authenticated bound hardware, and a formally published digital content packet is in a different structure from that of a cooperation content packet. In the illustrated embodiment, a content possessing device is a device A used by a network writer, and is referred to hereafter as “A.” Content cooperating devices are a device B1 used by an illustrator and a device B2 used by an editor, and are referred to hereafter as “B1” and “B2.” A content using device is a device C used by a consumer, and is referred to hereafter as “C.” In addition, there is further in the system a trusted content dealer D, referred to hereafter as “D.” D is responsible for operating a content cooperation management platform having a DRM function and a content sale platform, and D's responsibilities also include user authentication and issuance of a license. In this embodiment, for a symmetric encryption mechanism, particularly an Advanced Encryption Standard (AES), an International Data Encryption Algorithm (IDEA), etc., may be adopted; for a message digest function, MD5, SHA-1, etc., may be adopted; and for a digital signature, RSA, DSS and other algorithms may be adopted.

In the illustrated embodiment, users need to register prior to content cooperation particularly as follows.

D may be responsible for operating the content cooperation management platform having the DRM function and the content sale platform. D may obtain a pair of public and private keys from an authoritative authentication center and publishes its own public key certificate.

A, B1 and B2 may register their respective user identifiers ID(A), ID(B1) and ID(B2) on the content cooperation management platform operated by D and acquire USB keys, in which their own public and private keys are stored, from a registration section of D authorized by the authenticator center. For example, a micro smart card processor in the USB key may perform decryption, digital signing and other operations according to the stored private key of the user. D may publish a list of public keys of the registered users on the content cooperation management platform.

C may register a user identifier ID(C) on the content sale platform operated by D, and extract and upload its own device feature information through the DRM client to register the device. In order to protect the rights of the copyright owner, the sale platform may limit the number of devices which a user can register. For example, a user may be allowed to register at most six devices. After C completes device registration, D may generate a device key of D according to device information of C so that C may use the digital contents only on the registered device after being authorized.

FIG. 2B illustrates a flowchart of the method for digital content security cooperation, according to the second exemplary embodiment.

Step 211: A May Initialize a Cooperation Content Packet and Uploads a Content Key Ciphertext.

The user using A may select a function of “Encapsulate a cooperation content packet” via DRM client software after creating a first draft of works. The DRM client software may generate a unique content identifier i and a random content key CEK for the works, ask A to insert a USB key and generate an initialized cooperation content packet CP0 for A. In CP0, attribute information may include the content identifier i and a content possessing device identifier ID(A), an attribute signature may be generated by the USB key of A signing a digest of the attribute information by the private key of A, a content ciphertext may be generated by the DRM client software encrypting a plaintext of the works symmetrically by the CEK, an encapsulator identifier is ID(A), encapsulation time information may be a version sequence number of 0, and a content packet signature may be generated by the USB key of A signing a digest of the attribute information, the content ciphertext and the encapsulation time information by the private key of A.

After the initialized cooperation content packet CP0 is created, A may encrypt the CEK by the public key of D through the DRM client software, and upload CP0 and a ciphertext of the CEK to the cooperation management platform. After obtaining the foregoing information from the cooperation management platform, D may decrypt the ciphertext of the CEK by the private key and store the CEK securely in a data item corresponding to the contents i.

Step 212: A Authorizes B1 and B2 Through D.

Through the cooperation management platform, the user using A may add B1 and B2 as content cooperating devices of the contents i and set a privilege assigned to B1 to supplement an illustration for the works and a privilege assigned to B2 to check and modify the contents of the works after B1 supplements the illustration. Through the cooperation management platform, D may create cooperation licenses respectively for B1 and B2, each of which may include the content identifier i, the possessor identifier ID(A), a content key ciphertext, rights information granted by A to B1 or B2, the identifier of D, and a signature of D on a digest of the above information by its own private key. The content key ciphertext may be generated by D encrypting the CEK by the public key of B1 or B2.

Step 213: A Cooperates with B1 and B2 in Revising the Contents.

D may transmit the initialized content packet CP0 and the cooperation licenses to B1 and B2 through system messages.

After obtaining the cooperation license and CP0, B1 may first verify the signature of D in the cooperation license and the content packet signature and the attribute signature in CP0 through the DRM client software, and then confirm that the content identifier i in CP0 is consistent with the content identifier i in the cooperation license. Upon successful verification, the DRM client software of B1 may ask B1 to insert a USB key, and the USB key may be used to decrypt the content key ciphertext in the cooperation license by the private key of B1 and then transport the obtained content key CEK to the DRM client software of B1 over a secured channel for encrypting the content ciphertext in CP0 to present the content plaintext, and the user using B1 may add an illustration to the works as per the obtained privilege.

After the user using B1 completes the processing operations, the DRM client software of B1 may encrypt the updated plaintext of the works by the content key CEK extracted from the cooperation license into an updated content ciphertext of the works, and then create an updated cooperation content packet CP1, wherein attribute information of CP1 may be the same as the attribute information in CP0, an attribute signature of CP1 may be the same as the attribute signature in CP0, a content ciphertcxt of CP1 may be the updated content ciphertext, an encapsulator identifier of CP1 may be the user identifier of B1, ID(B1), encapsulation time information of CP1 may be a version sequence number of 1, and a content packet signature of CP1 may be a signature of the USB key of B1 on a digest of the attribute information of CP1, the content ciphertext of CP1 and the encapsulation time information of CP1 by the private key of B1.

After CP1 is encapsulated, B1 may transmit CP1 to B2 through a system message of the cooperation management platform. Through the DRM client software, B2 may first verify the signature of D in the cooperation license and the content packet signature and the attribute signature in CP1, and then confirm that the content identifier i in CP1 is consistent with the content identifier i in the cooperation license. Upon successful verification, the DRM client software of B2 may ask B2 to insert a USB key and decrypt the content key ciphertext in the cooperation license by the private key of B2, the USB key may transmit the obtained content key CEK to the DRM client software over a secured channel, the DRM client software may decrypt the content ciphertext in CP1 by the CEK and present the content plaintext, and the user using B2 may check and revises the works as per the obtained privilege.

After the user using B2 completes the processing operations, the DRM client software of B2 may encrypt the updated plaintext of the works by the content key CEK extracted from the cooperation license into an updated content ciphertext of the works, and then create an updated cooperation content packet CP2. For example, attribute information of CP2 may be the same as the attribute information in CP1, an attribute signature of CP2 may be the same as the attribute signature in CP1, a content ciphertext of CP2 may be the updated content ciphertext, an encapsulator identifier of CP2 may be the user identifier of B2, ID(B2), encapsulation time information of CP2 may be a current version sequence number of 2, and a content packet signature of CP2 may be a signature of the USB key of B2 on a digest of the attribute information of CP2, the content ciphertext of CP2 and the encapsulation time information of CP2 by the private key of B2.

Step 214: A Reviews the Contents and Generates a Formal Digital Content Packet.

B2 may transmit CP2 to A through a system message. A may verify the content packet signature and the attribute signature of CP2 through the DRM client software. Next, A may decrypt the content ciphertext in CP2 by the CEK, and the user using A may review and confirm the content plaintext and adjusts the content plaintext dependent upon a practical condition or asks B1 or B2 to repeat a cooperation effort until a finally determined content plaintext M is formed. After completing the confirmation, A may generate a new content key CEK randomly and create a formal digital content packet CP through the DRM client software. CP may include the content identifier i, the possessor identifier ID(A), a content ciphertext into which M is encrypted by the CEK′, and a signature of the USB key of A on a digest of these information by the private key of A.

Step 215: A Sells the Formal Content Packet Through D.

A may encrypts the CEK by the public key of D, and then upload CP and a ciphertext of the CEK to the cooperation management platform and select a function of “Formal publication” on the platform to request D for selling the digital works in CP on its behalf. D may decrypt the ciphertext of the CEK by the private key, and obtain and securely store the CEK.

Step 216. D Authorizes C to Use the Formally Published Contents.

D may publish commodity information of CP on the sale platform, and after C purchases and downloads CP successfully, D may create a use license for C, which may include the content identifier i, a content key ciphertext, use rights information of C and a signature of D on a digest of the above information by the private key. The content key ciphertext may be generated by D encrypting the content key CEK by the device key of C. After the license is created, D may transmit the use license onto C.

Before using the protected digital works, C may first verify the signatures in CP and the use license, respectively, and confirm that the content identifiers in CP and the use license are consistent. If the verification fails, C may transmit error information to D and request D for retransmitting a CP or a use license. If the verification is successful, C may extract the device information on the registered device through the DRM client software, generate a device key, decrypt the content key ciphertext in the use license by the device key, and decrypt the content ciphertext in CP by the obtained content key CEK. The user using C may then use the digital works in CP in accordance with a granted privilege.

Referring back to FIG. 1A, in exemplary embodiments, the content possessing device 102 may be configured to create a cooperation content packet of digital contents and to transmit the created cooperation content packet to another content possessing device and/or a content cooperating device, such as the content cooperating device 104. The cooperation content packet may include an attribute data block and a content data block, the attribute data block may include information that may be updated only by a content possessing device, and the content data block may include information that may be updated by a content possessing device and a content cooperating device.

In exemplary embodiments, the content possessing device 102 may be configured to perform privilege verification according to a received cooperation content packet, and after the privilege verification is passed, to update the information in the attribute data block and/or the content data block in the received cooperation content packet, and to transmit the cooperation content packet including the updated information to another content possessing device and/or content cooperating device.

In exemplary embodiments, the content cooperating device 104 may be configured to perform privilege verification according to the cooperation content packet after receiving the cooperation content packet from a content possessing device, such as the content possessing device 102, and after the privilege verification is passed, to update the information in the content data block in the cooperation content packet, and to transmit the cooperation content packet including the updated information to another content cooperating device and/or content possessing device.

In exemplary embodiments, the attribute data block may include attribute information and an attribute signature of the digital contents. The content data block may include a content ciphertext, and encapsulation information and a content packet signature of the cooperation content packet. The attribute signature may be a digital signature of the attribute information. Further, the content ciphertext may be a ciphertext into which the digital contents are encrypted by a content key. In addition, the content packet signature may be a digital signature of the content ciphertext, the encapsulation information and the attribute information, or a digital signature of the content ciphertext, the encapsulation information and the attribute signature.

In exemplary embodiments, the content possessing device 102 may further be configured to verify the attribute signature and the content packet signature in a received cooperation content packet, and after the verification is passed, to update the attribute information, the encapsulation information, the attribute signature and the content packet signature in the cooperation content packet, and to transmit the cooperation content packet including the updated attribute information, encapsulation information, attribute signature and content packet signature, and the content ciphertext prior to updating to another content possessing device and/or content cooperating device.

In exemplary embodiments, the content possessing device 102 may further be configured to verify the attribute signature and the content packet signature in a received cooperation content packet, and after the verification is passed, to decrypt the content ciphertext in the cooperation content packet by the content key, to update a content plaintext obtained by the decryption and to encrypt the updated content plaintext by the content key into an updated content ciphertext. The content possessing device 102 may also be configured to update the encapsulation information and the content packet signature in the cooperation content packet, and to transmit the cooperation content packet including the updated content ciphertext, encapsulation information and content packet signature, and the attribute information and the attribute signature prior to updating to another content possessing device and/or content cooperating device.

In exemplary embodiments, the content possessing device 102 may further be configured to verify the attribute signature and the content packet signature in a received cooperation content packet, and after the verification is passed, to update the attribute information in the cooperation content packet, to decrypt the content ciphertext in the cooperation content packet by the content key, to update a content plaintext obtained by the decryption and to encrypt the updated content plaintext by the content key into an updated content ciphertext. The content possessing device 102 may also be configured to update the encapsulation information, the attribute signature and the content packet signature in the cooperation content packet, and to transmit the cooperation content packet including the updated attribute information, attribute signature, content ciphertcxt, encapsulation information and content packet signature to another content possessing device and/or content cooperating device.

In exemplary embodiments, the content possessing device 102 may be configured to verify the attribute signature and the content packet signature in a cooperation content packet as follows. For example, the content possessing device 102 may sign the attribute information in the cooperation content packet by a private key, and compare the signature with the attribute signature in the cooperation content packet to thereby verify the attribute signature. The content possessing device 102 may further determine the device encapsulating the cooperation content packet according to the encapsulation information in the cooperation content packet, and may verify the content packet signature in the cooperation content packet by a public key corresponding to the device, and the content ciphertext, the encapsulation information and the attribute information or the attribute signature in the cooperation content packet.

In exemplary embodiments, the content possessing device 102 may further be configured to, after creating a cooperation content packet of the digital contents, issue a cooperation license of the created cooperation content packet to the content cooperating device 104 by itself or through a trusted third party. The cooperation license may include authorization information and an authorization signature. The authorization information may include the attribute information and a content key ciphertext in the cooperation content packet, the content key ciphertext being a ciphertext into which the content key is encrypted by a key stored or generated by bound hardware. The authorization signature may be a digital signature of the content possessing device on the authorization information.

In exemplary embodiments, the content cooperating device 104 may be configured to verify the authorization signature in the cooperation license, and the attribute signature and the content packet signature in the cooperation content packet, and after the verification is passed, to determine whether the attribute information in the cooperation license is consistent with the attribute information in the cooperation content packet. Upon positive determination, the content cooperating device 104 may be configured to obtain the key stored or generated by the bound hardware, to decrypt the content key ciphertext in the cooperation license by the key, to decrypt the content ciphertext in the cooperation content packet by the content key obtained by the decryption, to update the content plaintext obtained by the decryption, and to encrypt the updated content plaintext by the content key into an updated content ciphertext. The content cooperating device 104 may also be configured to update the encapsulation information and the content packet signature in the cooperation content packet, and to transmit the cooperation content packet including the updated content ciphertext, content packet signature and encapsulation information, and the attribute information and the attribute signature prior to updating to another content cooperating device and/or content possessing device.

In exemplary embodiments, the content cooperating device 104 may further be configured to verify the authorization signature in the cooperation license, and the attribute signature and the content packet signature in the cooperation content packet as follows. The content cooperating device 104 may verify the authorization signature in the cooperation license according to a public key of the device issuing the cooperation license and the authorization information in the cooperation license. The content cooperating device 104 may also determine the device encapsulating the cooperation content packet according to the encapsulation information in the cooperation content packet, and may verify the attribute signature and the content packet signature in the cooperation content packet by a public key corresponding to the device, and the content ciphertext, the encapsulation information and the attribute information or the attribute signature in the cooperation content packet. The content cooperating device 104 may further determine the content possessing device according to the attribute information in the cooperation content packet, and may verify the attribute signature in the cooperation content packet by a public key corresponding to the determined content possessing device and the attribute information in the cooperation content packet.

In exemplary embodiments, when the key used to generate the content key ciphertext is a public key stored or generated by the bound hardware, the key used by the content cooperating device 104 to decrypt the content key ciphertext in the cooperation license may be a private key stored or generated by the bound hardware.

In exemplary embodiments, when the key used to generate the content key ciphertext is a symmetric key stored or generated by the bound hardware, the key used by the content cooperating device 104 to decrypt the content key ciphertext in the cooperation license may be the symmetric key.

In exemplary embodiments, the authorization information further includes rights information used to declare a processing operation that can be performed by the content cooperating device on the cooperation content packet. The bound hardware is hardware residing in a specified area or hardware belonging to an authorized content cooperating device.

In exemplary embodiments, the content possessing device 102 may be further configured to verify the attribute signature and the content packet signature in the cooperation content packet after receiving the cooperation content packet transmitted from a content cooperating device, such as the content cooperating device 104, or another content possessing device, to decrypt the content ciphertext in the cooperation content packet by the content key after the verification is passed, and to create a digital content packet for formal publication according to the reviewed and confirmed content plaintext after a user reviews and confirms the content plaintext obtained by the decryption.

In exemplary embodiments, the attribute information may include a content identifier of the digital contents and an identifier of the content possessing device, and the encapsulation information may include an encapsulator identifier and encapsulation time information.

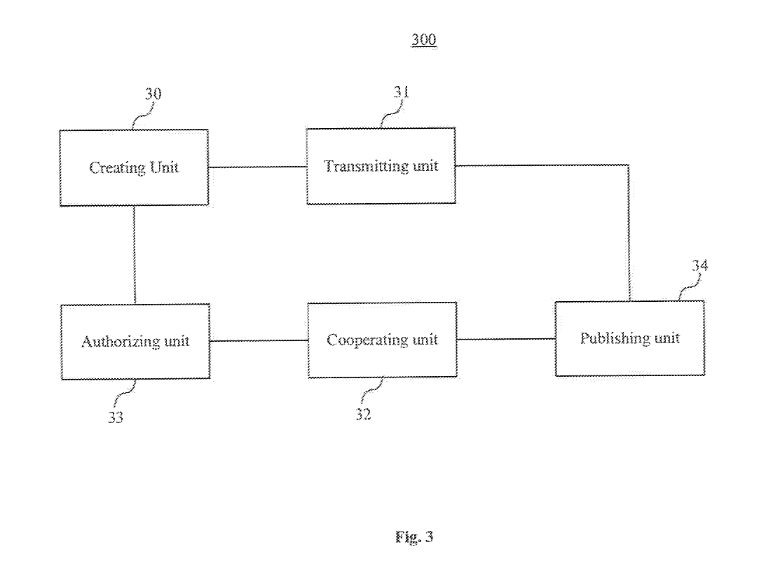

FIG. 3 illustrates a block diagram of a content possessing device 300, according to an exemplary embodiment. For example, the content possessing device 300 may be the content possessing device 102 (FIG. 1A). Referring to FIG. 3, the content possessing device 300 may include a creating unit 30, a transmitting unit 31, a cooperating unit 32, an authorizing unit 33, and a publishing unit 34.

In exemplary embodiments, the creating unit 30 may be configured to create a cooperation content packet of digital contents. The cooperation content packet may include an attribute data block and a content data block. The attribute data block may include information that may be updated only by a content possessing device, and the content data block may include information that may be updated by a content possessing device and a content cooperating device.

In exemplary embodiments, the transmitting unit 31 may be configured to transmit the created cooperation content packet to another content possessing device and/or content cooperating device.

In exemplary embodiments, the cooperating unit 32 may be configured to perform privilege verification according to a received cooperation content packet, and after the privilege verification is passed, to update the information in the attribute data block and/or the content data block in the cooperation content packet, and to transmit the cooperation content packet including the updated information to another content possessing device and/or content cooperating device.

In exemplary embodiments, the attribute data block may include attribute information and an attribute signature of the digital contents, and the content data block may include a content ciphertext, and encapsulation information and a content packet signature of the cooperation content packet. For example, the attribute signature is a digital signature of the content possessing device on the attribute information. Also for example, the content ciphertext may be a ciphertext into which the content possessing device encrypts the digital contents by a content key, and the content packet signature may be a digital signature of the content possessing device on the content ciphertext, the encapsulation information and the attribute information, or a digital signature of the content ciphertext, the encapsulation information and the attribute signature.

In exemplary embodiments, the cooperating unit 32 may also be configured: to verify the attribute signature and the content packet signature in the cooperation content packet, and after the verification is passed, to update the attribute information, the encapsulation information, the attribute signature and the content packet signature in the cooperation content packet, and to transmit the cooperation content packet including the updated attribute information, encapsulation information, attribute signature and content packet signature, and the content ciphertext prior to updating to another content possessing device and/or content cooperating device.

In exemplary embodiments, the cooperating unit 32 may further be configured to verify the attribute signature and the content packet signature in the cooperation content packet, and after the verification is passed, to decrypt the content ciphertext in the cooperation content packet by the content key, to update a content plaintext obtained by the decryption and to encrypt the updated content plaintext by the content key into an updated content ciphertext. The cooperating unit 32 may be additionally configured to update the encapsulation information and the content packet signature in the cooperation content packet, and to transmit the cooperation content packet including the updated content ciphertext, encapsulation information and content packet signature, and the attribute information and the attribute signature prior to updating to another content possessing device and/or the content cooperating device.

In exemplary embodiments, the cooperating unit 32 may further be configured to verify the attribute signature and the content packet signature in the cooperation content packet, and after the verification is passed, to update the attribute information in the cooperation content packet, to decrypt the content ciphertext in the cooperation content packet by the content key, to update a content plaintext obtained by the decryption and to encrypt the updated content plaintext by the content key into an updated content ciphertext. The cooperating unit 32 may be additionally configured to update the encapsulation information, the attribute signature and the content packet signature in the cooperation content packet, and to transmit the cooperation content packet including the updated attribute information, attribute signature, content ciphertext, encapsulation information and content packet signature to the other content possessing device and/or the content cooperating device.

In exemplary embodiments, the cooperating unit 32 may be further configured to verify the attribute signature and the content packet signature in the cooperation content packet as follows. For example, the cooperating unit 32 may sign the attribute information in the cooperation content packet by a private key, and compares the signature with the attribute signature in the cooperation content packet to thereby verify the attribute signature. The cooperating unit 32 may also determine the device encapsulating the cooperation content packet according to the encapsulation information in the cooperation content packet, and may verify the content packet signature in the cooperation content packet by a public key corresponding to the device, and the content ciphertext, the encapsulation information and the attribute information or the attribute signature in the cooperation content packet.

In exemplary embodiments, the authorizing unit 33 may be configured to issue a cooperation license of the created cooperation content packet to the content cooperating device by itself or through a trusted third party. The cooperation license may include authorization information and an authorization signature. The authorization information may include the attribute information and a content key ciphertext in the cooperation content packet, the content key ciphertext being a ciphertext into which the content key is encrypted by a key stored or generated by bound hardware. The authorization signature may be a digital signature of the content possessing device on the authorization information.

In exemplary embodiments, the publishing unit 34 may be configured to verify an attribute signature and a content packet signature in a cooperation content packet after receiving the cooperation content packet transmitted from the content cooperating device or the other content possessing device, to decrypt a content ciphertext in the cooperation content packet by a content key after the verification is passed, and to create a digital content packet for formal publication according to a reviewed and confirmed content plaintext after a user reviews and confirms the content plaintext obtained by the decryption.

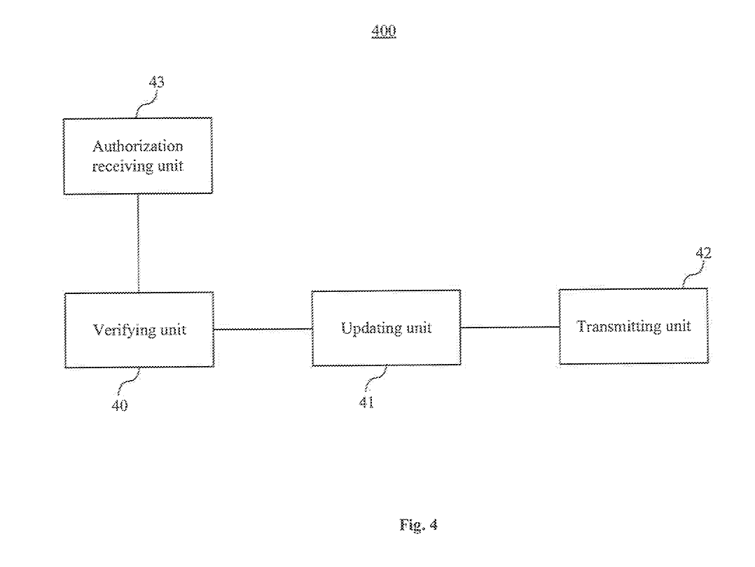

FIG. 4 illustrates a block diagram of a content possessing device 400, according to an exemplary embodiment. For example, the content possessing device 400 may be the content possessing device 104 (FIG. 1A). Referring to FIG. 4, the content possessing device 400 may include a verifying unit 40, an updating unit 41, a transmitting unit 42, and an authorization receiving unit 43.

In exemplary embodiments, the verifying unit 40 may be configured to perform privilege verification according to a cooperation content packet after receiving the cooperation content packet. The cooperation content packet may include an attribute data block and a content data block. The attribute data block includes information that may be updated only by a content possessing device, and the content data block includes information that may be updated by a content possessing device and a content cooperating device.

In exemplary embodiments, the updating unit 41 may be configured to update the information in the content data block in the cooperation content packet after the privilege verification is passed.

In exemplary embodiments, the transmitting unit 42 may be configured to transmit the cooperation content packet including the updated information to another content cooperating device and/or content possessing device.

In exemplary embodiments, the attribute data block may include attribute information and an attribute signature of the digital contents, and the content data block may include a content ciphertext, and encapsulation information and a content packet signature of the cooperation content packet. For example, the attribute signature may be a digital signature of the content possessing device on the attribute information. Also for example, the content ciphertext may be a ciphertext into which the content possessing device or the other content cooperating device encrypts the digital contents by a content key, and the content packet signature may be a digital signature of the content possessing device or the other content cooperating device on the content ciphertext, the encapsulation information and the attribute information, or a digital signature of the content ciphertext, the encapsulation information and the attribute signature.

In exemplary embodiments, the authorization receiving unit 43 may be configured to receive a cooperation license of the created cooperation content packet issued by the content possessing device itself or through a trusted third party. The cooperation license may include authorization information and an authorization signature. The authorization information may include the attribute information and a content key ciphertext in the cooperation content packet. The content key ciphertext may be a ciphertext into which the content key is encrypted by a key stored or generated by bound hardware, and the authorization signature may be a digital signature of the content possessing device on the authorization information.

The verifying unit 40 may further be configured to verify the authorization signature in the cooperation license, and the attribute signature and the content packet signature in the cooperation content packet, and to determine whether the attribute information in the cooperation license is consistent with the attribute information in the cooperation content packet after the verification is passed. The updating unit 41 may further be configured to, upon determination of consistency, obtain the key stored or generated by the bound hardware, to decrypt the content key ciphertext in the cooperation license by the key, to decrypt the content ciphertext in the cooperation content packet by the content key obtained by the decryption, to update the content plaintext obtained by the decryption, and to encrypt the updated content plaintext by the content key into an updated content ciphertext; and to update the encapsulation information and the content packet signature in the cooperation content packet. The transmitting unit 42 may further be configured to transmit the cooperation content packet including the updated content ciphertext, content packet signature and encapsulation information, and the attribute information and the attribute signature prior to updating to the other content cooperating device and/or the content possessing device.

In exemplary embodiments, the verifying unit 40 may further be configured to verify the authorization signature in the cooperation license, and the attribute signature and the content packet signature in the cooperation content packet as follows. For example, the verifying unit 40 may verify the authorization signature in the cooperation license according to a public key of the device issuing the cooperation license and the authorization information in the cooperation license. The verifying unit 40 may also determine the device encapsulating the cooperation content packet according to the encapsulation information in the cooperation content packet, and may verify the attribute signature and the content packet signature in the cooperation content packet by a public key corresponding to the device, and the content ciphertext, the encapsulation information and the attribute information or the attribute signature in the cooperation content packet. The verifying unit 40 may further determine the content possessing device according to the attribute information in the cooperation content packet, and verify the attribute signature in the cooperation content packet by a public key corresponding to the determined content possessing device and the attribute information in the cooperation content packet.

In exemplary embodiments, when the key used to generate the content key ciphertext is a public key stored or generated by the bound hardware, the key used by the updating unit 41 to decrypt the content key ciphertext in the cooperation license may be a private key stored or generated by the bound hardware.

In exemplary embodiments, when the key used to generate the content key ciphertext is a symmetric key stored or generated by the bound hardware, the key used by the updating unit 41 to decrypt the content key ciphertext in the cooperation license may be the symmetric key.

In exemplary embodiments, advantageous effects of the invention include at least the following.

In the exemplary embodiments, a cooperation content packet created by a content possessing device may include an attribute data block that may be updated only by a content possessing device and a content data block that may be updated by a content possessing device and a content cooperating device, and the content possessing device may update information in the attribute data block and the content data block after performing privilege verification, and the content cooperating device may update the information only in the content data block after performing privilege verification. The cooperation content packet may be divided into the attribute data block that may be updated only by the content possessing device, and the content data block that may be updated by the content possessing device and the content cooperating device, to ensure that the content cooperating device may process and re-encapsulate the cooperation content packet without altering attribute of digital contents, thus improving the security of the digital contents. The content possessing device and the authorized content cooperating device have their privileges on the cooperation content packet of respective versions unchanged to dispense with overheads of respective management and authorization for the respective versions.

In addition, a cooperation license may be bound with hardware to limit an operating scope of the content cooperating device and prevent the content cooperating device from abusing its rights and spreading maliciously the protected contents. Moreover, only the contents reviewed and confirmed by the content possessing device may be published formally in the end to ensure controllability of the content possessing device on publication of the contents. Furthermore, the invention will not be limited to any particular cooperation interaction flow but can be applied flexibly to a plurality of cooperation modes.

The invention has been described with reference to flow charts and/or block diagrams of the method, device, and system according to the exemplary embodiments. It shall be appreciated that respective flows and/or blocks in the flow charts and/or the block diagrams and combinations of the flows and/or the blocks in the flow charts and/or the block diagrams may be implemented by computer program instructions. These computer program instructions may be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow charts and/or the block(s) of the block diagrams.

These computer program instructions may also be stored into a computer readable memory capable of directing the computer or the other programmable data processing device to operate in a specific manner so that the instructions stored in the computer readable memory create manufactures including instruction means which perform the functions specified in the flow(s) of the flow charts and/or the block(s) of the block diagrams.

These computer program instructions may also be loaded onto a computer or a programmable data processing device so that a series of operational steps are performed on the computer or the programmable data processing device to create a computer implemented process so that the instructions executed on the computer or the programmable device provide steps for performing the functions specified in the flow(s) of the flow charts and/or the block(s) of the block diagrams.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

1. A method for digital content security cooperation, comprising:
creating, by a first content possessing device, a cooperation content packet of digital contents and transmitting the created cooperation content packet to at least one of a second content possessing device or a first content cooperating device, wherein the cooperation content packet includes an attribute data block and a content data block, the attribute data block includes information that may be updated only by a content possessing device, and the content data block includes information that may be updated by a content possessing device or by a content cooperating device;
performing, by the first content cooperating device receiving the cooperation content packet, privilege verification according to the cooperation content packet, and after the privilege verification is passed, updating the information in the content data block in the cooperation content packet, and transmitting the cooperation content packet including the updated information to at least one of a second content cooperating device or the first content possessing device; and
performing, by the first content possessing device, privilege verification according to the cooperation content packet after receiving the cooperation content packet, and after the privilege verification is passed, updating at least one of the information in the attribute data block or the content data block in the cooperation content packet and transmitting the cooperation content packet including the updated information.

2. The method according to claim 1, wherein the attribute data block including attribute information and an attribute signature of the digital contents, the content data block including a content ciphertext, and encapsulation information and a content packet signature of the cooperation content packet, and the method further comprises:
using a digital signature of the attribute information as the attribute signature;
encrypting the digital contents by a content key to generate the content ciphertext; and
using at least one of a first digital signature or a second digital signature as the content packet signature, the first digital signature being a digital signature of the content ciphertext, the encapsulation information, and the attribute information, and the second digital signature being a digital signature of the content ciphertext, the encapsulation information, and the attribute signature.

3. The method according to claim 2, wherein updating the information and transmitting the cooperation content packet including the updated information by the first content possessing device comprises at least one of:
updating the attribute information, the encapsulation information, the attribute signature and the content packet signature in the cooperation content packet, and transmitting the cooperation content packet including the updated attribute information, encapsulation information, attribute signature and content packet signature, and the content ciphertext prior to updating;
decrypting the content ciphertext in the cooperation content packet by the content key, updating a content plaintext obtained by the decryption and encrypting the updated content plaintext by the content key into an updated content ciphertext, updating the encapsulation information and the content packet signature in the cooperation content packet, and transmitting the cooperation content packet including the updated content ciphertext, encapsulation information and content packet signature, and the attribute information and the attribute signature prior to updating; or
updating the attribute information in the cooperation content packet, decrypting the content ciphertext in the cooperation content packet by the content key, updating a content plaintext obtained by the decryption and encrypting the updated content plaintext by the content key into an updated content ciphertext; updating the encapsulation information, the attribute signature and the content packet signature in the cooperation content packet, and transmitting the cooperation content packet including the updated attribute information, attribute signature, content ciphertext, encapsulation information and content packet signature.

4. The method according to claim 3, wherein performing the privilege verification by the first content possessing device comprises:
signing the attribute information in the cooperation content packet by a private key, and comparing the signature with the attribute signature in the cooperation content packet to verify the attribute signature, and
determining the device encapsulating the cooperation content packet according to the encapsulation information in the cooperation content packet, and verifying the content packet signature in the cooperation content packet by a public key corresponding to the device, and the content ciphertext, the encapsulation information and the attribute information or the attribute signature in the cooperation content packet.

5. The method according to claim 2, wherein after creating by the first content possessing device the cooperation content packet of the digital contents, the method further comprises:
issuing, by the first content possessing device, a cooperation license of the created cooperation content packet to the first content cooperating device by itself or through a trusted third party, wherein the cooperation license includes authorization information and an authorization signature, the authorization information includes the attribute information and a content key ciphertext in the cooperation content packet, the content key ciphertext is a ciphertext into which the content key is encrypted by a key stored or generated by bound hardware, and the authorization signature is a digital signature of the content possessing device on the authorization information.

6. The method according to claim 5, wherein performing, by the first content cooperating device, the privilege verification comprises:
verifying the authorization signature in the cooperation license, and the attribute signature and the content packet signature in the cooperation content packet, and
after the verification is passed, determining whether the attribute information in the cooperation license is consistent with the attribute information in the cooperation content packet.

7. The method according to claim 5, wherein updating the information and transmitting the cooperation content packet including the updated information by the first content cooperating comprises:
decrypting the content key ciphertext in the cooperation license and decrypting the content ciphertext in the cooperation content packet;
updating the content plaintext obtained by the decryption, and encrypting the updated content plaintext by the content key into an updated content ciphertext;
updating the encapsulation information and the content packet signature in the cooperation content packet; and
transmitting the cooperation content packet including the updated content ciphertext, content packet signature and encapsulation information, and the attribute information and the attribute signature prior to updating.

8. The method according to claim 7, wherein the verifying by the first content cooperating device comprises:
verifying the authorization signature in the cooperation license according to a public key of the device issuing the cooperation license and the authorization information in the cooperation license;
determining the device encapsulating the cooperation content packet according to the encapsulation information in the cooperation content packet, and verifying the content packet signature in the cooperation content packet by a public key corresponding to the device, and the content ciphertext, the encapsulation information and the attribute information or the attribute signature in the cooperation content packet; and
determining the content possessing device according to the attribute information in the cooperation content packet, and verifying the attribute signature in the cooperation content packet by a public key corresponding to the determined content possessing device and the attribute information in the cooperation content packet.

9. The method according to claim 7,
wherein when the key used to generate the content key ciphertext is a public key stored or generated by the bound hardware, the key used by the content cooperating device to decrypt the content key ciphertext in the cooperation license is a private key stored or generated by the bound hardware; and
when the key used to generate the content key ciphertext is a symmetric key stored or generated by the bound hardware, the key used by the content cooperating device to decrypt the content key ciphertext in the cooperation license is the symmetric key.

10. The method according to claim 5, wherein the authorization information further includes rights information used to declare a processing operation to be performed by the first content cooperating device on the cooperation content packet.

11. The method according to claim 5, wherein the bound hardware is hardware residing in a specified area or hardware belonging to an authorized content cooperating device.

12. The method according to claim 2, further comprising:
verifying, by the first content possessing device, the attribute signature and the content packet signature in the cooperation content packet after receiving the cooperation content packet transmitted from the content cooperating device or the other content possessing device, and after the verification is passed, decrypting the content ciphertext in the cooperation content packet by the content key, and after a user reviews and confirms the content plaintext obtained by the decryption, creating a digital content packet for formal publication according to the reviewed and confirmed content plaintext.

13. The method according to claim 2, wherein
the attribute information includes a content identifier of the digital contents and an identifier of the content possessing device; and
the encapsulation information includes an encapsulator identifier and encapsulation time information.

14. A system for digital content security cooperation, comprising a first content possessing device and a first content cooperating device, wherein:
the first content possessing device may be configured to create a cooperation content packet of digital contents and to transmit the created cooperation content packet to at least one of a second content possessing device or the first content cooperating device, wherein the cooperation content packet includes an attribute data block and a content data block, the attribute data block includes information that may be updated only by a content possessing device, and the content data block includes information that may be updated by a content possessing device or by a content cooperating device;
the first content cooperating device may be configured to perform privilege verification according to the cooperation content packet after receiving the cooperation content packet, and after the privilege verification is passed, to update the information in the content data block in the cooperation content packet, and to transmit the cooperation content packet including the updated information to at least one of a second content cooperating device or the first content possessing device; and
the first content possessing device is further configured to perform privilege verification according to the cooperation content packet after receiving the cooperation content packet, and after the privilege verification is passed, to update the information in at least one of the attribute data block or the content data block in the cooperation content packet, and to transmit the cooperation content packet including the updated information.
